(19) United States
(12) Patent Application Publication
(10) Pub. No.: US 2025/0329030 A1
(43) Pub. Date: Oct. 23, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Yasuhiro OKUNO, Tokyo (JP); Sohi KODAMA, Kanagawa (JP)

(21) Appl. No.: 19/180,223

(22) Filed: Apr. 16, 2025

(30) Foreign Application Priority Data
Apr. 23, 2024 (JP) 2024-069952

(51) Int. Cl. G06T 7/215; G06T 7/246

(52) U.S. Cl. CPC G06T 7/215; G06T 7/248; G06T 2207/30196

(57) ABSTRACT

There is provided with an information processing apparatus. A first detecting unit detects a subject from each of a first image and a second image that chronologically follows the first image. A second detecting unit detects, from each of the first and second images, a partial region showing a specific part relating to the subject. An acquiring unit acquires a state of a change, between the first and second images, in a quantity in which the partial region is detected. A first controlling unit, in accordance with the state of the change, performs control of whether or not to associate a specific part shown in the partial region extracted in the second image with the subject.

### BACKGROUND

### Technical Field

The present invention relates to an information processing apparatus, an information processing method, and a storage medium.

### Description of the Related Art

It is common to detect and track a region of a specific subject from consecutive images. Tracking is a technique in which a region of a desired subject is detected from images to continuously follow the same subject region between consecutive images. A result of the tracking is used as a basis for autofocus processing of the camera being used to capture images, etc.

Japanese Patent Laid-Open No. 2021-152578 discloses a method in which tracking is performed while associating the entirety of a tracking-target subject and a part of the tracking-target subject. For example, the entirety and the part of the subject are such that, in a case in which a person is the subject, the entire human body is the entirety, and the face portion is the part. In Japanese Patent Laid-Open No. 2021-152578, the entirety and the part are associated based on the positional relationship (e.g., the closeness of distance) between the body portion and the part portion of the subject.

### SUMMARY

According to one embodiment of the present disclosure, an information processing apparatus comprises: a first detecting unit configured to detect a subject from each of a first image and a second image that chronologically follows the first image; a second detecting unit configured to detect, from each of the first and second images, a partial region showing a specific part relating to the subject; an acquiring unit configured to acquire a state of a change, between the first and second images, in a quantity in which the partial region is detected; and a first controlling unit configured to, in accordance with the state of the change, perform control of whether or not to associate a specific part shown in the partial region extracted in the second image with the subject.

According to another embodiment of the present disclosure, an information processing method comprises: detecting a subject from each of a first image and a second image that chronologically follows the first image; detecting, from each of the first and second images, a partial region showing a specific part relating to the subject; acquiring a state of a change, between the first and second images, in a quantity in which the partial region is detected; and performing, in accordance with the state of the change, control of whether or not to associate a specific part shown in the partial region extracted in the second image with the subject.

According to yet another embodiment of the present disclosure, a non-transitory computer-readable storage medium stores a program that, when executed by a computer, causes the computer to perform an information processing method, the information processing method comprising: detecting a subject from each of a first image and a second image that chronologically follows the first image; detecting, from each of the first and second images, a partial region showing a specific part relating to the subject; acquiring a state of a change, between the first and second images, in a quantity in which the partial region is detected; and performing, in accordance with the state of the change, control of whether or not to associate a specific part shown in the partial region extracted in the second image with the subject.

Further features of the present disclosure will become apparent from the following description of exemplary embodiments (with reference to the attached drawings).

### BRIEF DESCRIPTION OF THE DRAWINGS

FIG. 1 is a block diagram illustrating an example of a configuration of an information processing apparatus according to embodiment 1.

FIG. 2 is a flowchart illustrating an example of overall processing by the information processing apparatus.

FIG. 3 is a flowchart illustrating an example of processing by a state acquiring unit.

FIG. 4 is a flowchart illustrating an example of processing by a threshold setting unit.

FIG. 5 is a flowchart illustrating an example of processing by an associating unit.

FIG. 6 is a flowchart illustrating an example of processing by a display controlling unit.

FIGS. 7A and 7B are diagrams for describing a state in which a local-portion detection count changes.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made an disclosure that requires all such features, and multiple such features may be combined as appropriate. Furthermore, in the attached drawings, the same reference numerals are given to the same or similar configurations, and redundant description thereof is omitted.

The method of associating an entirety and a part based on the positional relationship therebetween poses a problem that the entirety and the part would not be associated correctly when similar objects cross each other at the same position in an image. For example, there is a problem with the technique disclosed in Japanese Patent Laid-Open No. 2021-152578 that an erroneous association would be formed should the head of another person cross the head of the tracking-target person when a person is being tracked.

Embodiments of the present disclosure suppress the erroneous formation of an association of a specific part with a subject.

### Embodiment 1

In the following, an information processing apparatus according to embodiment 1 will be described. The information processing apparatus according to the present embodiment: receives chronologically consecutive images as input; tracks a subject detected from each of the images and tracks the entirety of the tracking-target subject; and also can detect a specific part relating to the subject and associate the specific part with the subject. In the following, when the wording “specific part” is simply used, the “specific part” refers to a specific part that relates to such a processing-target subject and that is detected by the information processing apparatus according to the present embodiment. Furthermore, hereinafter, such a specific part may be referred to as a “local portion” or a “local part”.

In the present embodiment, description will be provided of an example in which a human body (entire human body) is used as a processing-target subject, and the head of the human body is used as a specific part relating to the subject; however, there is no particular limitation to such a form as long as similar processing can be executed. For example, as a subject and a specific part thereof, the head and a pupil of a human body, an animal (entire body) and the face of the animal, a vehicle and a number plate, etc., may be used. Furthermore, a specific part does not necessarily have to be a part of a subject, as along as the specific part is expected to be captured in images so as to accompany the subject. For example, a rideable object such as a vehicle or an animal, and the head of a person riding the rideable object may be used as a subject and a specific part thereof. While the head of the person is not a part of the rideable object, the head can be regarded as a specific part relating to the subject because the head moves together with the tracking-target rideable object.

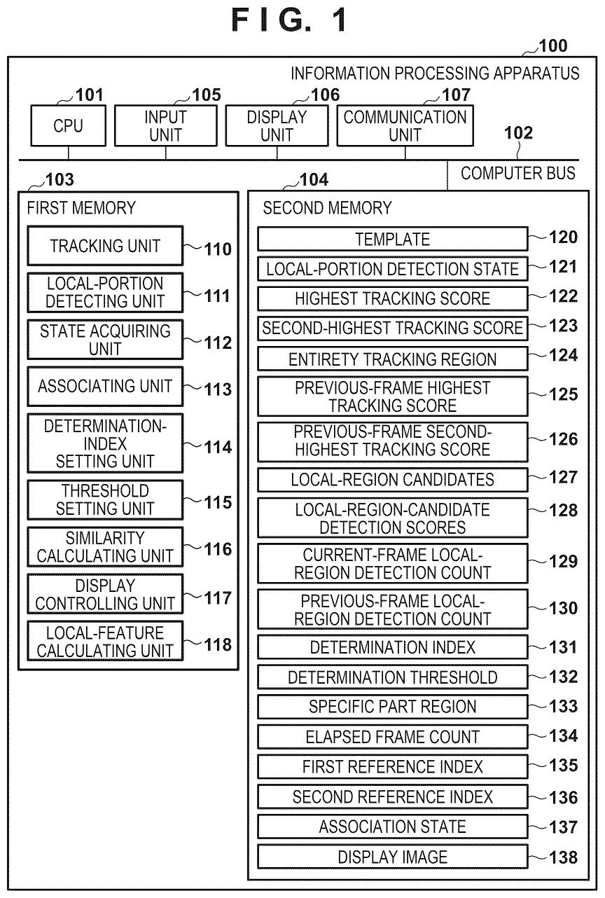

FIG. 1 is a diagram illustrating an example of a configuration of an information processing apparatus 100 according to the present embodiment. As an example of a hardware configuration thereof, the information processing apparatus 100 includes a CPU 101, a computer bus 102, a first memory 103, a second memory 104, an input unit 105, a display unit 106, and a communication unit 107. The CPU 101 controls the entire information processing apparatus 100. The first memory 103 and the second memory 104 are memories that store various types of data and one or more control programs for executing processing according to the present embodiment. FIG. 1 illustrates that the first memory 103 mainly stores control programs and the second memory 104 mainly stores various types of data; however, there is no limitation to such a form as long as similar data can be stored in the information processing apparatus 100 as a whole.

The input unit 105 is formed from a keyboard, a touchscreen, or the like, and receives input from a user. The display unit 106 is formed from a display device such as a liquid-crystal display, and can display processing results to the user. The communication unit 107 can communicate with external devices and exchange data therewith. The computer bus 102 connects the functional units of the information processing apparatus 100. For example, the information processing apparatus 100 according to the present embodiment may be implemented as a computer that includes one or more programs for executing the types of processing described in the following.

In the present embodiment, the first memory 103 stores the one or more programs for executing types of processing to be described as being executed by the information processing apparatus 100. The local-feature calculating unit 118 illustrated in FIG. 1 will be described in embodiment 2.

A tracking unit 110 tracks a subject in images. The tracking of the subject by the tracking unit 110 can be executed by using, as appropriate, commonly used techniques for tracking a subject in images, and, for example, the tracking may be executed by template matching, a machine learning model trained in advance so as to track a subject in images, or the like. Description will be provided in the following assuming that the tracking unit 110 according to the present embodiment detects and tracks the subject by template matching.

A local-portion detecting unit 111 a partial region (local region) showing a specific part from the images. The local-portion detecting unit 111 according to the present embodiment detects a local region from each of a first image and a second image that chronologically follows the first image. The detection of the specific part by the local-portion detecting unit 111 can be performed by means of conventional processing for detecting an object in images. Here, the local-portion detecting unit 111 detects the local part using a machine learning model trained in advance so as to detect the specific part in images. Hereinafter, the first image and the second image may be respectively referred to as a previous frame (image) and a current frame (image).

A state acquiring unit 112 acquires a state of a change, between the first and second images, in a quantity in which the local region is detected by the local-portion detecting unit 111. For example, the state acquiring unit 112 acquires information as to whether the quantity in which the local region is detected has increased, decreased, or not changed between the first and second images. Hereinafter, such a state of a change, between the first and second images, in the quantity of local regions may be referred to simply as a “change state”. A specific example of the processing by the state acquiring unit 112 will be described later.

An associating unit 113 associates the local region (specific part) detected by the local-portion detecting unit 111 with the tracking-target subject. A plurality of local regions may be detected from an image, in which case the associating unit 113 selects the most suitable local region based on a predetermined condition and associates the selected local region with the tracking-target subject. Hereinafter, such processing of “associating a local region with the subject” is regarded as being equivalent in content to processing of associating the specific part corresponding to such a local region with the subject. In the present embodiment, the processing by the associating unit 113 of associating the local region with the subject is controlled in accordance with the change state acquired by the state acquiring unit 112. In particular, a threshold set by the later-described threshold setting unit 115 is controlled in accordance with the change state, and the associating unit 113 associates the local region and the subject using the threshold controlled in such a manner.

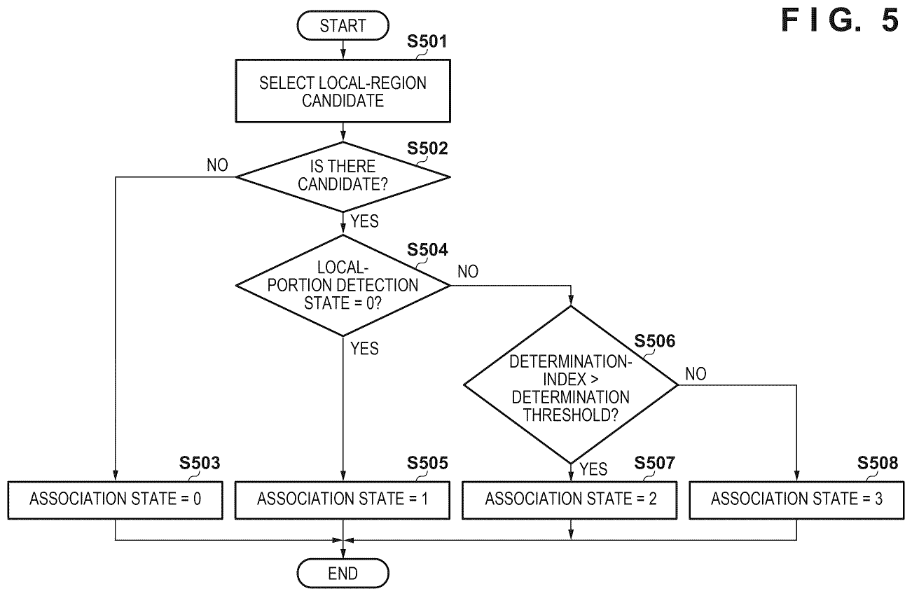

For example, the associating unit 113 may inhibit the local region detected in the second image from being associated with the subject if the quantity of detected local regions has decreased in the second image compared to in the first image. As described in detail later with reference to FIG. 5, it can be assumed that one or more local regions are concealed if the quantity of detected local regions decreases with the elapse of time. From such a viewpoint, such processing by the associating unit 113 makes it possible to inhibit the association from being formed in a case in which the possibility of an erroneous association being formed has increased. Accordingly, situations in which a negative impression is provided to the user due to an erroneous association being formed (e.g., due to a bounding box being displayed on an incorrect target, etc.) can be reduced, and situations in which subsequent processing, such as tracking processing, is adversely affected by an erroneous association being formed can be reduced. The processing by the associating unit 113 will be described in detail later with reference to FIG. 5.

The processing for inhibiting the association from being formed is not particularly limited, as long as the processing makes it less likely for the local region to be associated with the subject in a case in which the quantity of detected local regions has decreased in the second image compared to in the first image. For example, a configuration may be adopted such that: the associating unit 113 associates the local region with the subject without using the later-described determination threshold 132 if the quantity of local regions detected in the second image is equal to or more than that in the first image; and the associating unit 113 sets an additional condition (e.g., use of the later-described determination threshold 132) for forming the association if the quantity of detected local regions has decreased in the second image compared to in the first image. Furthermore, for example, the processing for inhibiting the association from being formed may be processing in which the threshold used for forming the association is increased, or processing such that display indicating that the association is inhibited from being formed is additionally performed.

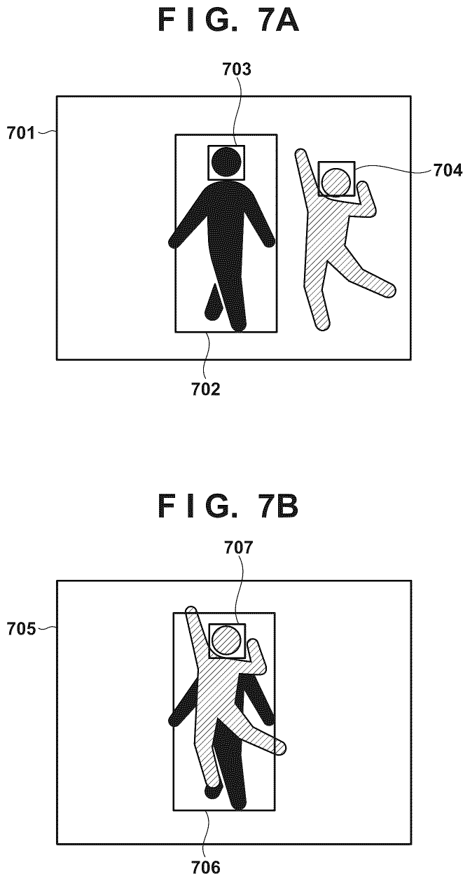

If the entirety of a subject and a specific part are associated solely based on the positional relationship therebetween using the conventional technique, even a specific part that does not correspond to the subject would be erroneously associated with the subject if positions match. In a scene where people cross each other, specific parts (for example the heads) of the two people may overlap in position, and thus a specific part that should not be associated may appear in the same position. FIGS. 7A and 7B are diagrams for describing a situation in which a local-portion detection count decreases due to an overlap of specific parts of subjects. FIG. 7A describes a state in which the local-portion detection count is 2 for an input image 701. An entirety tracking frame 702 is a frame indicating an entirety tracking region 124 showing the tracked subject. Local-portion detection frames 703 and 704 display, by frames, two local regions that have been detected as local-part regions and that are stored in local-region candidates 127. FIG. 7B illustrates an input image 705 that is a frame subsequent to that in FIG. 7A. In the input image 705, the local-portion detection count has decreased from 2 in the previous frame to 1 due to the people overlapping. A local-portion detection frame 707 in FIG. 7B is a region in which a local part has been detected in the frame in FIG. 7B. As is the case in FIG. 7A, an entirety tracking frame 706 is a frame indicating the entirety tracking region 124 showing the tracked subject. In the example in FIG. 7B, a local part of another person has overlapped with the position of the actual local part accompanying the tracking-target subject. There was a problem with the conventional method that the subject and the specific part cannot be correctly associated in such a case. On the other hand, controlling whether or not to associate a specific part with a subject in accordance with the state of the change in the quantity of detected partial regions has the effect that it becomes possible to suppress the erroneous formation of an association as described above.

A determination-index setting unit 114 sets a determination index. The determination index according to the present embodiment is an evaluation value for evaluation that is used to associate a subject and a local part in an image. In the present embodiment, the later-described highest tracking score is used as the determination index.

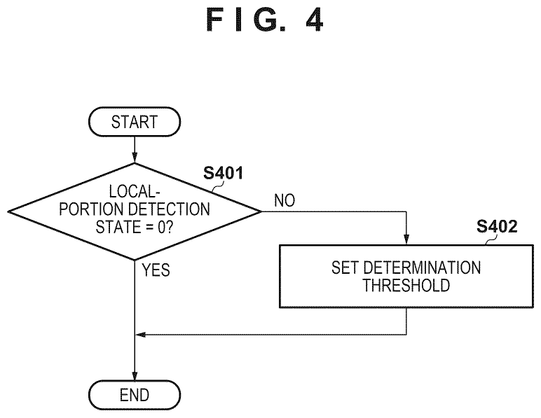

The threshold setting unit 115 sets a threshold to be applied to the determination index 131. For example, a configuration may be adopted such that the threshold setting unit 115 according to the present embodiment sets the threshold (as a determination threshold 132) based on later-described Formula (1) if there has been a decrease in the quantity of detected local regions based on the change state. The processing by the threshold setting unit 115 will be described later with reference to FIG. 4.

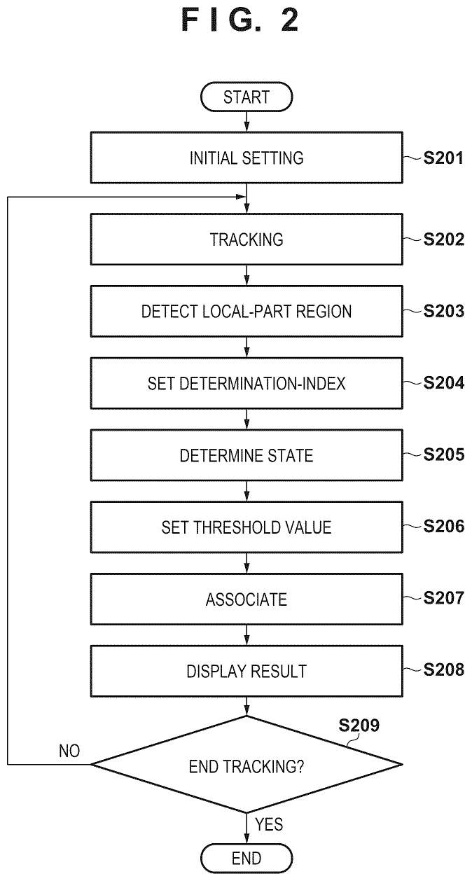

FIG. 2 is a flowchart illustrating an example of the entire information processing executed by the information processing apparatus 100 according to embodiment 1. In step S201, the information processing apparatus 100 performs initial setup of data relating to various types of processing. For example, as initial setup, the tracking unit 110 registers a template of a tracking-target subject to a template 120 in the memory 104. For example, this processing can be executed by receiving a selection of a subject on a screen by the user, or the like. In this example, the subject is the entirety of a person, and a full-body image of the person is registered as the template of the tracking target.

Furthermore, for example, as initial setup, the state acquiring unit 112 performs initial setup of a memory for storing the local-portion detection (local-region detection) state. The state acquiring unit 112 according to the present embodiment manages the state of the change in the quantity of detected local regions using an ID (e.g., represented by a value between 0 and 1), and can set 0 as the initial value of the ID.

Furthermore, for example, the local-portion detecting unit 111 initializes memories for storing quantities of detected local regions. Here, the local-portion detecting unit 111 stores the quantity of local regions detected from the current frame and the quantity of local regions detected from the previous frame as a current-frame local-region detection count 129 and a previous-frame local-region detection count 130 in the memory 104, respectively, and can set 0 as the initial values thereof.

In step S202, the tracking unit 110 executes processing for tracking the subject in a processing-target image. Here, the tracking unit 110 acquires a single-frame image that is the processing target, searches the image for a region resembling the template 120, and outputs a tracking region and a tracking score. The tracking score according to the present embodiment is an evaluation value obtained by evaluating tracking accuracy (value indicating the reliability of the tracking result), and the higher the value, the higher the likelihood of the tracking result. Here, the tracking unit 110 calculates a plurality of tracking-region candidates in the image, and adopts one of the tracking-region candidates having the highest tracking score as the tracking region of the subject (tracking result). For example, a tracking score for a candidate can be calculated based on the degree of match with the tracking region in the previous frame, the image similarity between the tracking region and the template, or the like. Here, the tracking unit 110 stores the scores for the candidate having the highest tracking score and the candidate having the second-highest tracking score as a highest tracking score 122 and a second-highest tracking score 123 in the memory 104, and stores the tracking region of the candidate having the highest tracking score in an entirety tracking region 124 in the memory 104. In the present embodiment, regions including the tracking region are each represented by the position and size of a bounding box (rectangular region) in the image. Note that, before executing the above-described tracking processing and storing the highest tracking score 122 and the second-highest tracking score 123, the tracking unit 110 stores the highest tracking score and the second-highest tracking score in the previous frame. The highest tracking score and the second-highest tracking score in the previous frame are stored in the memory 104 as a previous-frame highest tracking score 125 and a previous-frame second-highest tracking score 126.

In step S203, the local-portion detecting unit 111 detects a local part from the image. Here, from the input image, the local-portion detecting unit 111 detects a region of a local part accompanying the tracking-target subject, and outputs the local region and a local region detection score. Here, because the head of a human body is detected as a local part, a rectangular region surrounding the head of a human body is output as the local region. The local region detection score is a value indicating the reliability of the detection result, and the higher the value, the higher the likelihood of the detection result. Note that, in a case such as that in which a region whose local region detection score is higher than a predetermined threshold (can be set as appropriate) is detected as a local region, for example, a plurality of local parts may be detected from one image. In the example in FIG. 1, the local-portion detecting unit 111 stores local-region candidates 127 and local-region-candidate detection scores 128 in the memory 104. The local-region candidates 127 and the local-region-candidate detection scores 128 are arrays that store a plurality of detection results. The quantity of local regions detected in the current frame is stored as a current-frame local-region detection count 129 in the memory 104.

In step S204, the determination-index setting unit 114 stores a determination index 131 in the memory 104. The determination index is used in the association processing by the later-described associating unit 113. The determination-index setting unit 114 in the present embodiment uses the highest tracking score 122 as the determination index 131. Note that, as described in detail later in embodiment 2, an index other than a tracking score may be used as the determination index 131.

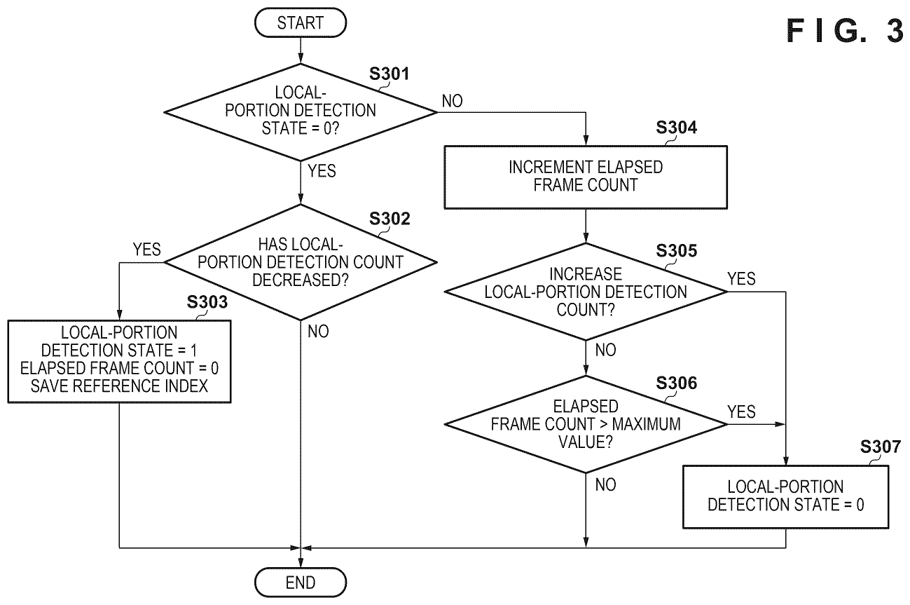

In step S205, the state acquiring unit 112 acquires the change state of the processing-target frame from the previous frame. In the present embodiment, the state acquiring unit 112 stores an ID (value) identifying the change state as a local-portion detection state 121 in the memory 104. Here, the state acquiring unit 112 stores “1” as the local-portion detection state 121 if the quantity of detected local regions has decreased in the current frame compared to in the previous frame, and stores “0” as the local-portion detection state 121 if the quantity of detected local regions has increased. The processing executed in step S205 will be described in detail later with reference to FIG. 3.

In step S206, the threshold setting unit 115 sets a threshold to be applied to the determination index 131. Here, the threshold setting unit 115 stores a determination threshold 132 as the threshold in the memory 104. The processing by the threshold setting unit 115 will be described in detail later.

In step S207, the associating unit 113 associates the subject and a local region. Here, the associating unit 113 can select one of the plurality of candidates included in the local-region candidates 127 and associate the selected candidate with the subject. Information indicating the local region associated with the subject is stored in the memory 104 as a local-part region 133. If there is no local region associated with the subject, information indicating that there is no associated local region is stored as the local-part region 133. Furthermore, the associating unit 113 stores a value corresponding to the reason why the association has been formed in an association state 137. Such types of processing by the associating unit 113 will be described in detail later.

In step S208, the display controlling unit 117 displays the tracking result on the display unit 106. For example, the display controlling unit 117 can display frames indicating the entirety tracking region 124 and the local-part region 133 in different colors on the input image. A configuration may be adopted such that, if the local-part region 133 is empty (there is no associated local region), no frame corresponding to the local-part region 133 is displayed. Furthermore, a configuration may be adopted such that, if a local part candidate has not been associated with the subject by the associating unit 113 based on the result of the determination by the state acquiring unit 112 even though the candidate is located near the tracking subject (e.g., within a predetermined area centered around the subject), the display controlling unit 117 displays a region frame corresponding to the candidate in a color different from that in the case in which it is determined that an association is to be formed. The processing by the display controlling unit 117 will be described in detail later.

In step S209, the information processing apparatus 100 determines whether or not to end the tracking processing. Processing returns to step S202 if tracking is to be continued; otherwise, the processing in FIG. 2 ends. The condition for determining whether or not to end the tracking processing may be set as appropriate. For example, the information processing apparatus 100 may determine that the tracking target has been lost and end the tracking processing if the highest tracking score 122 falls below a predetermined threshold. Alternatively, in assumption of use in an autofocus function of a camera, a configuration may be adopted such that the information processing apparatus 100 determines the start and end of tracking in accordance with whether or not a predetermined operation, such as a half-press of a shutter button, has been performed by the user, for example.

Next, the processing executed by the state acquiring unit 112 will be described in detail. FIG. 3 is a flowchart illustrating an example of the processing in step S205. In step S301, the state acquiring unit 112 branches processing in accordance with the current local-portion detection state 121. Here, the state acquiring unit 112 advances processing to step S302 if the local-portion detection state is 0, and advances processing to step S304 if the local-portion detection state is 1.

In step S302, the state acquiring unit 112 determines whether or not the quantity of detected local regions (local-portion detection count) in the current frame has decreased from that in the previous frame. The state acquiring unit 112 can perform this determination by comparing the current-frame local-region detection count 129 and the previous-frame local-region detection count 130 in the memory 104. Processing advances to step S303 if the local-portion detection count has decreased from the previous frame, and the processing in FIG. 3 ends if the local-portion detection count is equal to or has increased compared to that in the previous frame.

In step S303, the state acquiring unit 112 sets the local-portion detection state 121 in the memory 104 to 1. A decrease of the local-portion detection count in comparison with the previous frame suggests that the local-portion detection count may have decreased due to positions of a plurality of local regions overlapping. If this state is established, there is a possibility that the local part accompanying the tracking-target subject is concealed; thus, the threshold used by the associating unit 113 is controlled. Furthermore, in step S303, the state acquiring unit 112 sets an elapsed frame count 134 in the memory 104 in order to count the quantity of frames that have elapsed after the local-portion detection state is changed, and initializes the elapsed frame count 134 to 0. In addition, the state acquiring unit 112 stores the previous-frame highest tracking score 125 and the previous-frame second-highest tracking score 126 in the memory at this time point as a first reference index 135 and a second reference index 136 in the memory 104, respectively. The first reference index 135 is for recording how high the tracking score value was in a state immediately before the decrease of the local-portion detection count. Here, tracking scores are stored as reference indices because, in the present embodiment, the determination-index setting unit 114 uses a tracking score as the determination index for determining whether or not an association is to be formed. If an evaluation value other than a tracking score is used as the determination index 131, the determination index used by the determination-index setting unit 114 is stored in the first reference index 135.

In step S304, i.e., in a case in which the local-portion detection state 121 is determined as being 1 in step S301, the state acquiring unit 112 increments the elapsed frame count 134 in the memory 104 by one.

In step S305, the state acquiring unit 112 determines whether or not the local-portion detection count has increased. This determination can be performed by comparing the current-frame local-region detection count 129 and the previous-frame local-region detection count 130 in the memory 104. Processing advances to step S306 if the local-portion detection count is equal to or has decreased compared to that in the previous frame in step S305, and processing advances to step S307 if the local-portion detection count has increased from the previous frame in step S305.

In step S306, the state acquiring unit 112 determines whether or not the elapsed frame count 134 in the memory 104 has exceeded a separately set maximum value (predetermined number of frames) of the elapsed frame count. Processing advances to step S307 if the elapsed frame count 134 has exceeded the predetermined frame count; otherwise, the processing in FIG. 3 is ended.

In step S307, the state acquiring unit 112 sets the local-portion detection state 121 in the memory 104 to 0. Accordingly, the local-portion detection state 121 is set to 0 in step S307 if the local-portion detection count has increased or the elapsed frame count 134 has exceeded the predetermined maximum value. An increase of the local-portion detection count following a temporary decrease thereof suggests that the desired local part, which was concealed by another object, may have reappeared. Furthermore, an elapsed frame count higher than the predetermined maximum value suggests that the expectation may be low of the desired local part reappearing. From such viewpoints, the local-portion detection state 121 is set to the initial value 0 in step S307 in both of the above-described cases. In the later-described processing by the associating unit 113, association processing for associating the subject and a local region is executed based on the local-portion detection state 121 set by the state acquiring unit 112 as described above. As a result of the state acquiring unit 112 setting the local-portion detection state based on the increase/decrease in the quantity of detected local regions and the associating unit 113 associating the subject and a local region based on such a local-portion detection state, it becomes possible to appropriately control whether or not to associate a specific part with the subject in accordance with the state of the change in the quantity of detected local regions. Accordingly, errors in which an incorrect specific part is associated with the subject can be reduced.

Note that the local-portion detection count may also decrease due to reasons other than a local region of the tracking-target subject being concealed; such reasons include the movement of the head of a non-tracking-target subject to the outside of the frame, for example. Furthermore, in such cases, an erroneous association would not be formed even if the simple conventional technique is used. From such a viewpoint, while description has been provided in FIG. 3 that the local-portion detection state is set to 1 if there has been a decrease in the quantity of detected local regions, a configuration may be adopted such that the local-portion detection state is set to 1 if the quantity of local regions is 1. Such processing makes it possible to carefully check, based on the determination index 131, whether or not a detected local part accompanies the tracking target only if the local-portion detection count decreases from 2 or more to 1, and thereby simplify the overall processing accordingly.

Next, the processing by the threshold setting unit 115 will be described. The threshold setting unit 115 sets a threshold (determination threshold 132) to be applied to the determination index 131 in accordance with the state of the change in the quantity of local regions. Here, because a tracking score is used as the determination index 131 in the present embodiment, the determination threshold 132 set by the threshold setting unit 115 is a threshold relating to the tracking score.

FIG. 4 is a flowchart illustrating an example of the processing in step S206. In step S401, the threshold setting unit 115 determines whether or not the local-portion detection state 121 is 0. The threshold setting unit 115 ends processing without setting the determination threshold 132 as a threshold (i.e., an initial value is used as a threshold) if the local-portion detection state 121 is 0; otherwise, processing advances to step S402. Here, the determination threshold 132 is not used and thus does not need to be set if the local-portion detection state 121 is 0.

In step S402, the threshold setting unit 115 sets the determination threshold 132 based on the first reference index 135 and the elapsed frame count 134 in the memory 104. For example, the threshold setting unit 115 can calculate the determination threshold 132 based on Formula (1) below.

$$Th = {S}_{1} \times {α}^{f} \qquad Formula ( 1 )$$

Here, Th is the determination threshold 132, S₁ is the first reference index 135, and f is the elapsed frame count 134. Furthermore, α is a coefficient that is set in advance within the range of 0 to 1, inclusive. If α is 1, the first reference index 135 is always used as the determination threshold 132 regardless of the elapsed frame count 134. On the other hand, if α is less than 1, the determination threshold 132 decreases commensurately as the elapsed frame count increases.

In the first reference index 135, a tracking score when the local-portion detection state 121 was 0, i.e., a tracking score in a state in which the local part accompanying the tracking-target subject was not concealed, is stored. Here, the determination threshold is reduced commensurately as the elapsed frame count increases because, as time elapses after the local-portion detection state 121 is set to 1, the tracking score may decrease due to a change in the position of the human body that is the tracking-target subject, etc.

Note that, while description is provided here that the determination threshold 132 decreases in accordance with the elapsed frame count (if α is less than 1), the method according to which the threshold setting unit 115 sets the determination threshold 132 is not particularly limited to such a method. For example, a product obtained by multiplying the first reference index 135 by a predetermined coefficient may be set as the determination threshold 132, and the determination threshold 132 may be maintained regardless of the elapsed frame count. Furthermore, a determination threshold in a case in which the local-portion detection state 121 is 0 may be set in advance, and the value may be maintained at all times.

Alternatively, the threshold setting unit 115 may calculate the determination threshold 132 based on Formula (2) below by also using the second reference index 136. Here, S2 is the second reference index 136.

$$Th = max ( {S}_{1} \times {α}^{f} , {S}_{2} ) \qquad Formula ( 2 )$$

As the second reference index 136, the second-highest tracking score, i.e., a tracking score for a tracking candidate that was not determined as the tracking target, in the previous frame at the time point when the local-portion detection state 121 is set to 1 is stored. The use of Formula (2) has the effect that the determination threshold 132 is set so that the determination threshold 132 at least does not fall below the tracking score of a tracking candidate that was determined as not being the tracking target in a past frame.

Furthermore, while description has been provided here that the coefficient α is a fixed value, a configuration may be adopted such that the coefficient α is set based on the first reference index 135 and the second reference index 136, for example. For example, the threshold setting unit 115 may set the determination threshold 132 such that the determination threshold 132 has the same value as the second reference index when the elapsed frame count equals a predetermined value (N). For example, upon calculating the determination threshold 132 based on Formula (2), the threshold setting unit 115 may use a calculated based on Formula (3) below.

$$α = {10}^{\frac{log \frac{{S}_{1}}{{S}_{2}}}{N}} \qquad Formula ( 3 )$$

Formula (3) is a formula obtained by solving S₁×α^{N}=S₂ for α. By setting a in such a manner, the determination threshold 132 decreases from the first reference index 135 to the second reference index 136 in N frames from when the local-portion detection state 121 is set to 1, and the determination threshold is fixed at the second reference index thereafter. Such a configuration has the effect that the determination threshold can be prevented from falling below the tracking score of a tracking candidate that was not determined as the tracking target in the past.

Next, the processing by the associating unit 113 will be described. The region of the tracking-target subject is stored in the memory 104 as the entirety tracking region 124, and zero or more regions that are candidates of a local part are stored as the local-region candidates 127. The associating unit 113 selects a local region to be associated with a local part accompanying the tracking-target subject from among the candidates included in the local-region candidates 127, and stores the selected local region in the local-part region 133 in the memory 104. Furthermore, the associating unit 113 stores, in the memory 104 as the association state 137, a value (to be described later; indicated using the four levels of 0 to 3 here) indicating the reason why the state of association has been determined

FIG. 5 is a flowchart illustrating an example of the processing in step S207. In step S501, the associating unit 113 selects a local region from among the local-region candidates. The processing in step S501 is processing of selecting a local region to be associated with a local part accompanying the tracking-target subject from among the candidates included in the local-region candidates 127, and can be executed using, as appropriate, a publicly known technique for making a selection from among candidate regions. For example, from among the local-region candidates, the associating unit 113 may select a local-region candidate that is located at the closest distance from the entirety tracking region 124 in the image, or may select a local-region candidate based on the positional relationship (e.g., the direction (up, down, left, or right) in which the local-region candidate is present) with the entirety tracking region 124, or the like. Furthermore, the position of the head is captured in images so as to be located higher than the position of the center of the human body in most cases; thus, in a case in which the local part is the head of a human body, the associating unit 113 may add, to the conditions of the selection in step S501, the condition of being located above the entirety tracking region 124 in the image. Alternatively, in a case in which the frame rate is fast to some extent, the position of the local part would not move significantly from the previous frame; from this viewpoint, the associating unit 113 may select, from among the local-region candidates, a local-region candidate that is close in distance from the local-part region 133 in the previous frame in step S501. Alternatively, a configuration may be adopted such that the depth distance from the image-capturing device to the subject is calculated by an unillustrated calculation unit, and the local region for which the difference between the depth distance to the entirety tracking region and the depth distance of the local region is smallest is selected in step S501.

In step S502, the associating unit 113 determines whether or not there is a candidate that has been selected in step S501. Processing advances to step S503 if there is no selected candidate, and advances to step S504 if there is a selected candidate.

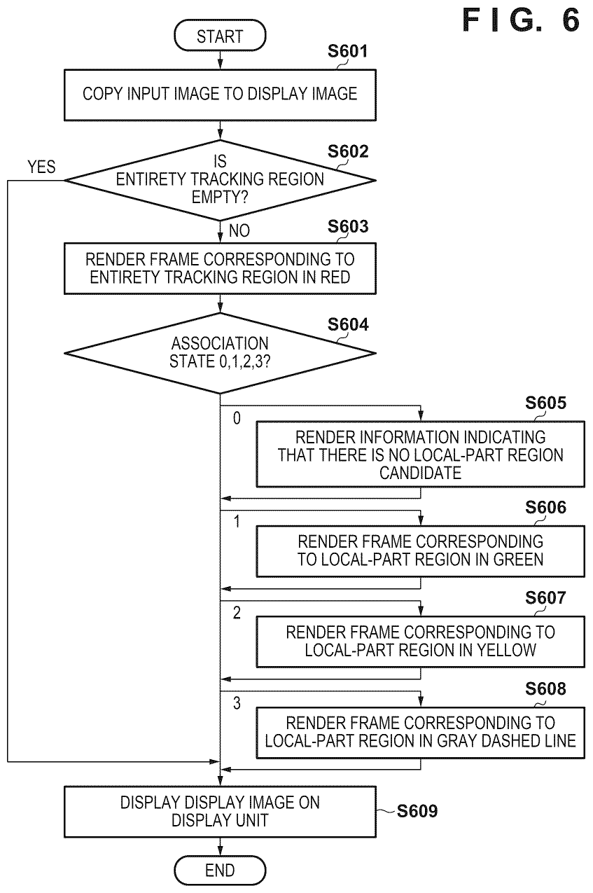

In step S503, the associating unit 113 does not associate any local region with the subject, and ends the processing in FIG. 5. In this example, the associating unit 113 sets the association state 137 in the memory 104 to 0. Here, the value 0 of the association state 137 indicates that no local part accompanying the tracked subject was detected, and thus it was determined not to form an association. Processing in accordance with the association state will be described later with reference to FIG. 6.

In step S504, the associating unit 113 determines whether or not the local-portion detection state 121 in the memory 104 is 0. Processing advances to step S505 if the local-portion detection state 121 is 0, and otherwise advances to step S506. In step S505, the associating unit 113 ends the processing in FIG. 5 after associating the local region selected in step S501 with the subject and storing information indicating that no decrease in the quantity of detected local regions has occurred. Here, by setting the association state 137 to 1, the associating unit 113 stores information indicating that the local region selected in step S501 is associated with the subject and information indicating that no decrease in the quantity of detected local regions has occurred. The “setting of the association state 137 to 1 (or 2 as described later)” may be information indicating that a local region corresponding to the option selected in step S501 is associated with the subject; alternatively, information indicating such a local region may be separately stored, in which case the “setting of the association state 137 to 1 (or 2 as described later)” may be information indicating that such a local region and the subject are associated. Here, the value 1 of the association state 137 indicates that: there is a local part accompanying the tracked subject; and no decrease in the local-portion detection count has occurred either because the local-portion detection state is 0, and the possibility is high that the local part to be associated with the tracking-target subject is not concealed in the current frame.

In step S506, the associating unit 113 determines whether or not the determination index 131 in the memory 104 is more than the determination threshold 132. Processing advances to step S507 if the determination index 131 is more than the determination threshold 132, and otherwise advances to step S508.

In step S507, the associating unit 113 ends the processing in FIG. 5 after associating the local region selected in step S501 with the subject and storing information indicating that a decrease in the quantity of detected local regions has occurred. Here, by setting the association state 137 to 2, the associating unit 113 stores information indicating that the local region selected in step S501 is associated with the subject and information indicating that a decrease in the quantity of detected local regions has occurred. Here, the value 2 of the association state 137 indicates that, while there is a possibility that the local part to be associated with the tracking-target subject is concealed in the current frame because a decrease in the local-portion detection count has been observed, the possibility is high that the local part is not concealed because the determination index is more than the threshold. Note that, in step S507, the local-portion detection state 121 may be set to the initial value 0. This is because the desired local part is not concealed, and it is determined that the current state can be regarded as the initial state. If the check using the determination index should also be performed in the subsequent frame, the local-portion detection state 121 may be maintained at 1.

In step S508, the associating unit 113 ends the processing in FIG. 5 after storing information indicating that the local region selected in step S501 is not associated with the subject. Here, by setting the association state 137 to 3, the associating unit 113 stores information indicating that the local region selected in step S501 is not associated with the subject. Here, the value 3 of the association state 137 indicates that: there is a possibility that the local part to be associated with the tracking-target subject is concealed in the current frame because a decrease in the local-portion detection count has been observed; and the possibility is high that the local part is concealed because the determination index is less than or equal to the threshold.

Note that, in a case in which the association state 137 is set to 3 in such a manner, the reliability of a local part associated with the tracking-target subject according to the conventional method would be low. Accordingly, if the association state 137 is 3, the associating unit 113 determines that there is no local part to be associated so that processing in which the entire subject and a local part are associated would not be executed. For example, in a case in which autofocus processing is being executed so that focus is adjusted to a local part accompanying the tracked subject, processing for determining that the focus target is lost is executed if the association state 137 is 3.

Furthermore, the information processing apparatus 100 may be configured so as to execute autofocus processing based on the determination result recorded in the association state 137 (autofocus processing set in advance so as to correspond to the value of the association state 137). For example, a configuration is conceivable in which various types of processing, such as restarting from the initial setup of tracking or waiting for a few frames until the desired local part reappears while maintaining the focus position, are associated with the association state 137 in advance, and such processing is executed in accordance with the association state 137. Furthermore, a configuration may be adopted such that, in a case as described later in which a local part accompanying the tracked subject is displayed, processing such as stopping display on the local-part region or changing the representation of display on the local-part region is executed based on the association state 137.

Furthermore, in the description of the associating unit 113 in the present embodiment, description has been provided that the determination threshold 132 is set by the threshold setting unit 115 in step S206 in FIG. 2, and determination by comparing the determination threshold 132 with the determination index 131 is performed in step S506 in FIG. 5; however, such processing may be omitted. In such a case, it is sufficient that processing advance to step S508 at all times without performing the determination by comparison in step S506. In this case, if a decrease in the local-portion detection count is observed, the associating unit 113 would always set the association state 137 to 3 and determine not to form an association.

Next, the processing by the display controlling unit 117 will be described. The display controlling unit 117 displays the tracking result on the display unit 106. The display controlling unit 117 according to the present embodiment can display a local region associated with the subject in a form based on the association state 137. As one example, the display controlling unit 117 displays, on the input image, a frame indicating the entirety tracking region 124 and a frame indicating the local-part region 133 in different colors.

In the following, description will be provided of an example in which the display form of a local region is changed in accordance with the association state 137. Note that such processing is an example, and the form of display is not limited to this. FIG. 6 is a flowchart illustrating an example of the processing in step S208. In step S601, the display controlling unit 117 copies the input image to display image 138. In step S602, the display controlling unit 117 determines whether or not the entirety tracking region 124 is empty (whether or not there is a local region stored as the entirety tracking region 124). If the entirety tracking region 124 is empty, processing advances to step S609, where the input image is displayed directly as the display image 138 and processing ends. Processing advances to step S603 if the entirety tracking region 124 is not empty.

In step S603, the display controlling unit 117 advances processing to step S609 after performing control so that a frame corresponding to the entirety tracking region 124 in the memory 104 is rendered and overlaid in red on the display image 138. The entirety tracking region 124 is a bounding box indicating the region of the tracking-target subject. In step S604, the display controlling unit 117 branches processing in accordance with the value stored in the association state 137. Here, processing advances to step S605, S606, S607, or S608 if the association state 137 is 0, 1, 2, or 3, respectively.

In step S605, the display controlling unit 117 advances processing to step S609 after performing control so that information indicating that there was no local part accompanying the tracking-target subject is rendered and overlaid on the display image 138. Here, a configuration may be adopted such that, as the information indicating that there was no local part accompanying the tracking-target subject, text to that effect is rendered and overlaid on the display image, or control may be performed so that no additional overlaid display is performed.

In step S606, the display controlling unit 117 advances processing to step S609 after performing control so that a frame corresponding to the local-part region 133 is rendered and overlaid in green on the display image 138. This representation indicates that, because no decrease in the quantity of local parts is observed in the current frame, a local part has been associated according to the conventional association method.

In step S607, the display controlling unit 117 advances processing to step S609 after performing control so that a frame corresponding to the local-part region 133 is rendered and overlaid in yellow on the display image 138. This representation indicates that, while there is a possibility that the desired local part is concealed because a decrease in the quantity of detected local parts has been observed, it has been determined that the association of the local part is valid because the tracking score that is the determination index is more than the determination threshold and thus the tracking-target subject is visible without being concealed. That is, it has been determined that the quantity of local parts has decreased in the current frame as a result of the head of a person differing from the subject being concealed.

In step S608, the display controlling unit 117 advances processing to step S609 after performing control so that a frame corresponding to the local-part region 133 is rendered and overlaid using a gray dashed line on the display image 138. This representation indicates that it has been determined that the association of the local part according to the conventional association method is invalid because the quantity of detected local parts has decreased in the current frame and the tracking score that is the determination index is equal to or less than the determination threshold. A configuration may be adopted such that the local-part region is not displayed in this case.

In step S609, the display controlling unit 117 ends processing after displaying the display image 138 on the display unit 106. Here, the display controlling unit 117 displays the display image 138 in the form controlled in step S602, S605, S606, S607, or S608. Note that, while description has been provided in FIG. 6 that frames are displayed in different colors, this is an example of display in which frames are displayed in different forms, and there is no particular limitation to display being performed in such a manner. For example, distinction may be performed by using a solid line, a dashed line, a dash-dot line, etc., as types of frame lines, or by applying hatching to areas inside frames, etc.

Such processing makes it possible to appropriately control whether or not to associate a specific part with the subject in accordance with the state of the change in the quantity of detected local regions. Accordingly, errors in which an incorrect specific part is associated with the subject can be reduced. Note that the entirety tracking region 124, the local-part region 133, or the association state 137 may be transmitted to an external device (e.g., an external device that operates based on the result of the tracking by the information processing apparatus 100) via the communication unit 107 in FIG. 1.

### Embodiment 2

In embodiment 1, a tracking score was used as the determination index 131. In embodiment 2, the similarity between image features of local-part regions is used as the determination index 131. In particular, here, the similarity between a feature amount of a local region associated with the subject in the first image, and a feature amount of a local region in the second image is used.

The local-feature calculating unit 118 according to the present embodiment can calculate image features of two or more image regions input thereto, and calculate the similarity between the calculated image features. The method of calculating the similarity between two images based on image features is commonly known, and detailed description of the processing involved in the method is omitted herein. For example, the local-feature calculating unit 118 can calculate a similarity used in a method in which the similarity of a face image is calculated and personal authentication is performed based on the face image. In the present embodiment, some of the processing described as being executed in embodiment 1 are modified.

The information processing apparatus 100 according to the present embodiment can basically execute processing similar to that in embodiment 1. In the following, description will be provided of processing executed by the information processing apparatus 100 according to embodiment 2 that is different from that in embodiment 1, and redundant description is omitted.

In step S204 according to the present embodiment, the determination-index setting unit 114 stores, in the determination index 131, the image features of candidates stored in the local-region candidates 127 as the determination index 131. Processing other than this illustrated in FIG. 2 is the same as that in embodiment 1, and description thereof is thus omitted here.

In step S303 according to the present embodiment, the state acquiring unit 112 calculates an image feature of the local-part region in the previous frame as a reference index, and stores the calculated image feature as the first reference index 135. Furthermore, the state acquiring unit 112 may store, as the second reference index 136, an image feature of a candidate that was not determined as being a local part accompanying the tracking-target subject in the previous frame. Processing other than this illustrated in FIG. 3 is the same as that in embodiment 1, and description thereof is thus omitted here.

In step S402 in FIG. 4, the threshold setting unit 115 sets, as the determination threshold 132, a threshold to be applied to the similarity between the first reference index 135 and the image feature of a candidate stored in the local-region candidates 127. This threshold may be set in advance as predetermined value. If face authentication is used as the local-feature calculating unit 118, there are cases in which a similarity threshold for identifying the same person is provided, and it is sufficient that the threshold be set as the determination threshold 132. Furthermore, the threshold setting unit 115 may examine the change in the similarity of images of a tracked local region using test data to set an appropriate threshold (in accordance with conditions desired by the user) in advance, and set the threshold value as the determination threshold 132. Processing other than this illustrated in FIG. 4 is the same as that in embodiment 1, and description thereof is thus omitted here.

In step S506 in FIG. 5, the associating unit 113 compares the image feature stored in the first reference index 135 and the image feature corresponding to the candidate selected in step S501 among the image features stored in the determination index 131, and calculates the similarity therebetween. Next, the associating unit 113 uses the calculated similarity as the determination index 131 and performs a determination by comparing the determination index 131 with the determination threshold 132. Note that a configuration may be adopted such that, here, the similarity between the second reference index 136 and the determination index 131 is also calculated, and processing advances to step S508 if the similarity with the second reference index is higher than the similarity with the first reference index. Such a configuration has the effect that it is ensured that an association is not formed if the similarity with the second reference index 136, which is an image feature of a region that was not determined as the desired local part in the previous frame at which the local-portion detection state 121 was set to 1, is higher. Processing other than this illustrated in FIG. 5 is the same as that in embodiment 1, and description thereof is thus omitted here.

Such a configuration has the effect that association processing can be executed suitably based on the local-portion detection state 121 and the similarity between images of local-part regions by using an image feature as the determination index 131.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-069952, filed Apr. 23, 2024, which is hereby incorporated by reference herein in its entirety.

What is claimed is:

1. An information processing apparatus comprising:
at least one processor; and
at least one memory having stored thereon instructions which, when executed by the at least one processor, cause the information processing apparatus at least to:
detecting a subject from each of a first image and a second image that chronologically follows the first image;
detecting, from each of the first and second images, a partial region showing a specific part relating to the subject;
acquiring a state of a change, between the first and second images, in a quantity in which the partial region is detected; and
in accordance with the state of the change, performing control of whether or not to associate a specific part shown in the partial region extracted in the second image with the subject.

2. The information processing apparatus according to claim 1 further comprising instruction for performing the information processing apparatus:
calculating an evaluation value for determining a state of association from the partial region in the second image; and
setting, in accordance with the change in the state, a threshold to be applied to the evaluation value,
wherein, based on the evaluation value and the threshold, the information processing apparatus performs control of whether or not to associate the specific part shown in the partial region extracted in the second image with the subject.

3. The information processing apparatus according to claim 2,
wherein the information processing apparatus performs control so as not to associate the specific part shown in the partial region extracted in the second image with the subject if the quantity in which the partial region is detected has decreased in the second image compared to in the first image, and the evaluation value is less than the threshold.

4. The information processing apparatus according to claim 2,
wherein the evaluation value is a score obtained by evaluating a tracking accuracy of the subject in the second image.

5. The information processing apparatus according to claim 2,
wherein the threshold is set based on the evaluation value of the partial region having the highest evaluation value calculated by the calculating unit in the first image.

6. The information processing apparatus according to claim 5,
wherein the threshold is set further based on the evaluation value of the partial region having the second-highest evaluation value calculated by the calculating unit in the first image.

7. The information processing apparatus according to claim 6,
wherein the threshold is set further based on a quantity of frames that have elapsed from the first image at the second image.

8. The information processing apparatus according to claim 2,
wherein the evaluation value is a similarity between a feature amount of the partial region associated with the subject in the first image and a feature amount of the partial region in the second image.

9. The information processing apparatus according to claim 1,
wherein the information processing apparatus inhibits the specific part shown in the partial region extracted in the second image from being associated with the subject if the quantity in which the partial region is detected has decreased in the second image compared to in the first image.

10. The information processing apparatus according to claim 9,
wherein the information processing apparatus sets an additional condition for associating the specific part shown in the partial region extracted in the second image with the subject if the quantity in which the partial region is detected has decreased in the second image compared to in the first image.

11. The information processing apparatus according to claim 1 further comprising
controlling display indicating the partial region in the second image in accordance with the control of associating performed by the first controlling unit.

12. The information processing apparatus according to claim 11,
wherein the information processing apparatus displays, in the second image, a frame indicating the partial region if the partial region has been associated with the subject, and does not display, in the second image, a frame indicating the partial region if the partial region has not been associated with the subject.

13. An information processing method comprising:
detecting a subject from each of a first image and a second image that chronologically follows the first image;
detecting, from each of the first and second images, a partial region showing a specific part relating to the subject;
acquiring a state of a change, between the first and second images, in a quantity in which the partial region is detected; and
performing, in accordance with the state of the change, control of whether or not to associate a specific part shown in the partial region extracted in the second image with the subject.

14. A non-transitory computer-readable storage medium storing a program that, when executed by a computer, causes the computer to perform an information processing method, the information processing method comprising:
detecting a subject from each of a first image and a second image that chronologically follows the first image;
detecting, from each of the first and second images, a partial region showing a specific part relating to the subject;
acquiring a state of a change, between the first and second images, in a quantity in which the partial region is detected; and
performing, in accordance with the state of the change, control of whether or not to associate a specific part shown in the partial region extracted in the second image with the subject.
